(19) United States
(12) Patent Application Publication
(10) Pub. No.: US 2009/0166905 A1
(43) Pub. Date: Jul. 2, 2009

(54) Contact lens fabrication method and tool

(75) Inventor: Cheng-Hsiu Chen, Hukou Township (TW)

Correspondence Address: BACON & THOMAS, PLLC, 625 SLATERS LANE, FOURTH FLOOR, ALEXANDRIA, VA, 22314-1176, US

(73) Assignee: UNICON OPTICAL CO., LTD., Hukou Township (TW)

(21) Appl. No.: 12/003,807

(22) Filed: Jan. 2, 2008

(51) Int. Cl. B29D 11/00

(52) U.S. Cl. 264/1.38; 425/174.4

(57) ABSTRACT

A contact lens fabrication method of fabrication a contact lens by means of: pressing a male molding block of a supplementary tool into a cavity of a mold to squeeze a contact lens material into shape and to simultaneously cut off an excessive part of the contact lens material from a contact lens by means of a cut angle of sharp edge of the mold, and then curing the contact lens, and then separating the supplementary tool from the mold to have the contact lens be adhered to the surface of the male molding block, and then filling a buffer solution into the supplementary tool to have the contact lens be dipped in the buffer solution after quality examination of the contact lens, and then sealing a sealing film to the supplementary tool to form a finished contact lens product for sale.

### BACKGROUND OF THE INVENTION

1. Field of the Invention

The present invention relates generally to the fabrication of contact lenses and more particularly to a contact lens fabrication method and tool that uses a supplementary tool to match with a mold for molding a contact lens for enabling the finished contact lens to be directly packaged with the supplementary tool, saving much labor and time.

2. Description of the Related Art

In 1508, Leonard da Vinci first has the idea of placing a corrective lens directly onto the surface of the eye. In 1636, Rene Descartes proposed another idea in which a glass tube filled with liquid is placed in direct contact with the cornea. In 1887, Adolf Eugen Fick, a German physiologist, created the first successful contact lens. Glass-blown scleral lenses remained the only form of contact lens until the 1938 when polymethyl methacrylate (PMMA) was developed, Mullen and Obring use the plastic scleral lenses to manufacture. Obring developed Plexiglass series in New York in 1940. In 1961, Czech chemist Otto Wichterle invented soft contact lenses. In 1970, RGP (rigid gas-permeable) contact lenses were developed, and widely invited for the advantages of small diameter (about 9 mm) and gas permeability. In 1999, an important development was the launch of the first silicone hydrogels onto the market. These new materials have extremely high oxygen permeability with comfort performance.

Currently, there are three of contact lens fabrication methods been adopted, i.e., the latche cutting method, the cast molding method and the spin casting method. Either of the aforesaid three contact lens fabrication methods is used, the finished contact lenses must be dipped in a buffer solution to become soft, and then respectively packaged in an individual contact lens case for sale. These conventional contact lens fabrication methods are still not perfect because of the following drawbacks:

1. When the lathe cutting method is employed, the molten contact lens material is filled in a glass tube and then cured under a high temperature environment, and then the cured contact lens material stick thus obtained forms a circular raw lenses, and then the circular raw lenses are milled, ground and polished, and then the polished contact lenses are dipped in a buffer solution, and then the softened contact lenses are individually packaged. This fabrication method is complicated, requiring much labor and time. Further, a small mistake occurs during the fabrication, the fabrication must be stopped, and the defective rate may be greatly increased.

2. When the cast molding method is employed, the molten contact lens material is filled in between the bottom and top dies of the mold and cured by means of the application of a high pressure and a high temperature, and then each cured raw contact lens is ground and polished, and then each polished contact lens is dipped in a buffer solution, and then each softened contact lens is individually packaged. This fabrication has the same drawbacks of high consumption of labor and time and high defective rate, and therefore the manufacturing cost is high.

3. When the spin casting method is employed, the molten contact lens material is filled in a spinning mold, and caused by centrifugal force to spread in the cavity of the spinning mold evenly, and the contact lens material is then cured subject to the radiation of ultraviolet light, and then each raw contact lens thus obtained is ground and polished, and then each polished contact lens is dipped in a buffer solution, and then each softened contact lens is individually packaged. This fabrication method is also complicated. Only a skilled person can operate the fabrication equipment. In case of unstable spinning, the thickness of the contact lens thus made becomes uneven, and the optical axis of the contact lens may bias from the center.

4. The application of either of the aforesaid conventional contact lens fabrication methods requires a respective specially designed mold. When each contact lens is cured, it must be ground and polished, complicating the fabrication and increasing the risk of high defective rate. Therefore, these conventional contact lens fabrication methods cannot lower the contact lens manufacturing cost.

Therefore, it is desirable to provide a contact lens fabrication method and tool that eliminates the aforesaid drawbacks.

### SUMMARY OF THE INVENTION

The present invention has been accomplished under the circumstances in view. It is the main object of the present invention to provide a contact lens fabrication method and tool that simplifies the fabrication of contact lenses and improves the yield rate, and effectively lowers the manufacturing cost.

To achieve this and other objects of the present invention, the contact lens fabrication tool comprises a mold and a supplementary tool. The mold comprises a cavity that curves smoothly inwards, and a cut angle of sharp edge extending around the border of the cavity. The supplementary tool comprises a downwardly extending work space fitting the mold, a male molding block curved smoothly downwards in the work space for insertion into the cavity of the mold to squeeze a contact lens material into shape, a sloping bearing surface extending around the periphery of the male molding block, and a sealing plane extending around a bottom side of the work space for the bonding of a sealing film to seal a buffer solution in the work space after molding of a contact lens and removal of the molded contact lens with the supplementary tool from said mold.

The contact lens fabrication method uses the aforesaid contact lens fabrication tool. The method includes the step of pressing the male molding block of the supplementary tool into the cavity of the mold to squeeze a contact lens material into shape and to simultaneously cut off an excessive part of the contact lens material from the shape formed contact lens by means of the cut angle of sharp edge of the mold and the sloping bearing surface of the supplementary tool, and the step of curing the contact lens, the step of separating the supplementary tool from the mold to have the contact lens be adhered to the surface of the male molding block, the step of filling a buffer solution into the supplementary tool to have the contact lens be dipped in the buffer solution after quality examination of the contact lens, and the step of sealing a sealing film to the supplementary tool to form a finished contact lens product for sale.

For the fabrication of a color contact lens, a transfer printing technique or spray printing technique is employed to print the surface of the cavity of the mold with a color printing ink before putting a contact lens material into the cavity of the mold.

### BRIEF DESCRIPTION OF THE DRAWINGS

FIG. 1 is an exploded view of a contact lens fabrication tool in accordance with the present invention.

FIG. 2 is a sectional side view of the contact lens fabrication tool in accordance with the present invention, showing a contact lens material put in the cavity of the mold.

FIG. 3 corresponds to FIG. 2, showing the male molding block of the supplementary tool forced into the cavity of the mold.

FIG. 4 corresponds to FIG. 3, showing the supplementary tool separated from the mold, the waste material of overflowed part of the contact lens material left secured to the locating blocks of the mold and the shape formed contact lens adhered to the surface of the male molding block of the supplementary tool.

FIG. 5 is a sectional side view of the present invention, showing the contact lens adhered to the surface of the male molding block of the supplementary tool and a buffer solution filled in the work space of the supplementary tool.

FIG. 6 corresponds to FIG. 5, showing a sealing film sealed to the sealing plane of the supplementary tool.

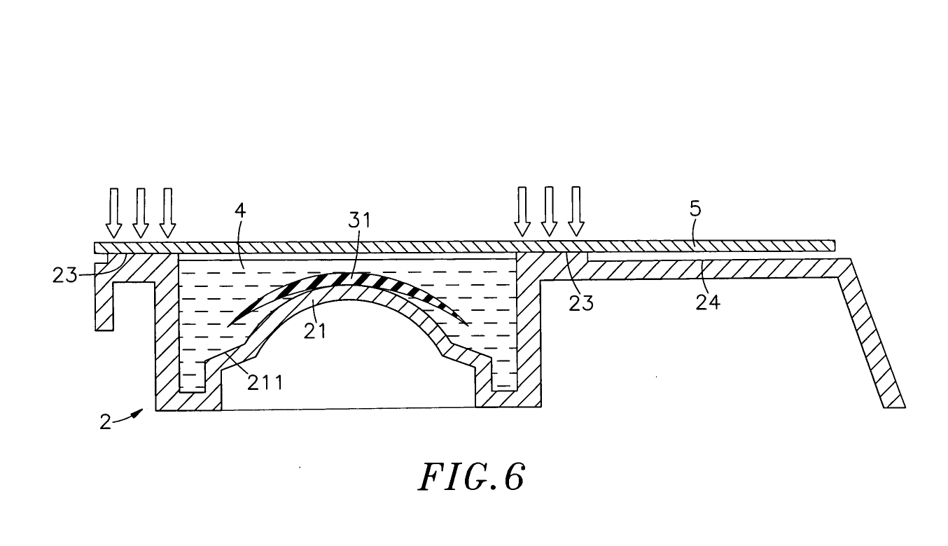

FIG. 7 illustrates a steel ink pad and a plastic transfer printing head of the contact lens fabrication tool in accordance with the present invention.

FIG. 8 is a sectional view of the present invention, showing the plastic transfer printing head aimed at the cavity of the mold before printing.

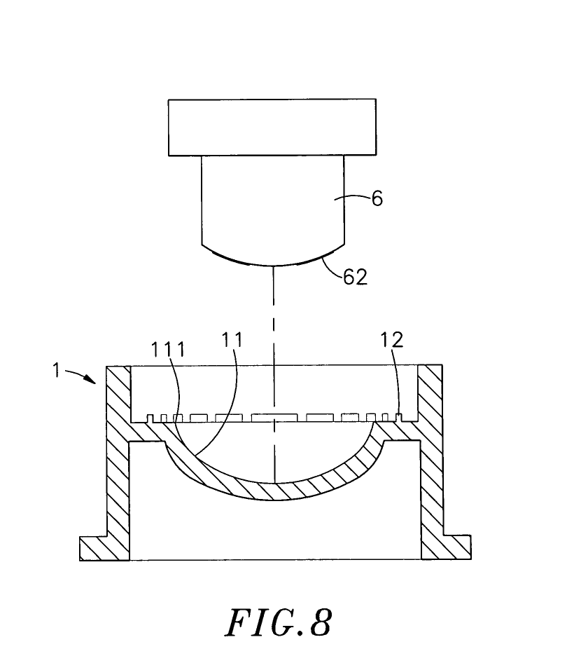

FIG. 9 corresponds to FIG. 8, showing the color printing ink printed on the surface of the cavity of the mold.

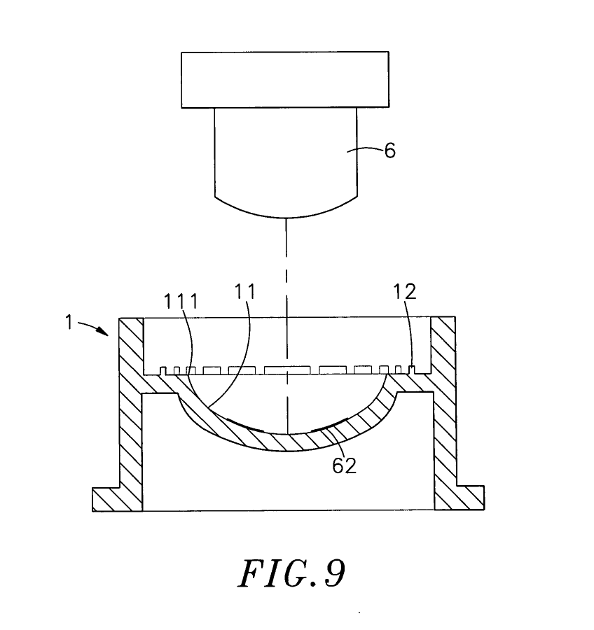

FIG. 10 is a sectional view, showing the surface of the cavity of the mold printed with the color printing ink and a contact lens material put in the cavity of the mold according to the present invention.

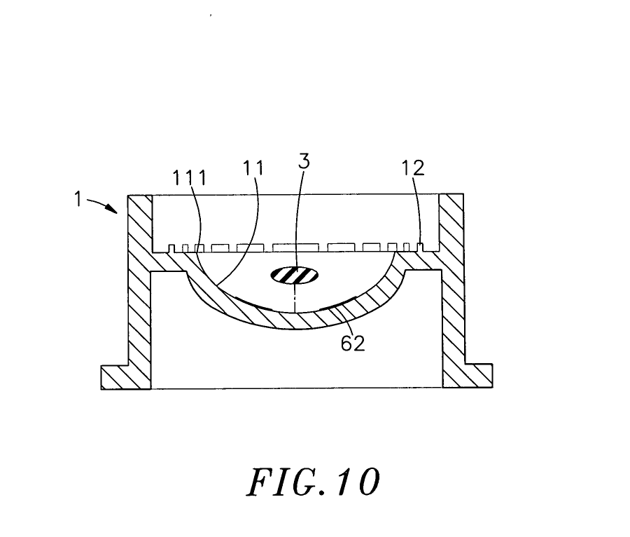

FIG. 11 is a sectional side view, showing the male molding block of the supplementary tool forced into the cavity of the mold after printing of the color printing ink on the surface of the cavity of the mold and putting of the contact lens material in the cavity of the mold according to the present invention.

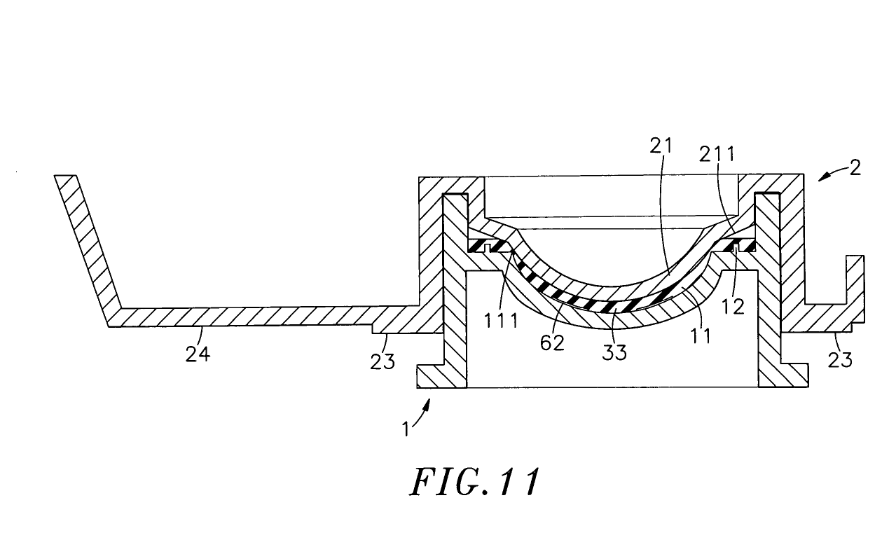

FIG. 12 corresponds to FIG. 11, showing the supplementary tool separated from the mold, the waste material of overflowed part of the contact lens material left secured to the locating blocks of the mold and the color contact lens adhered to the surface of the male molding block of the supplementary tool.

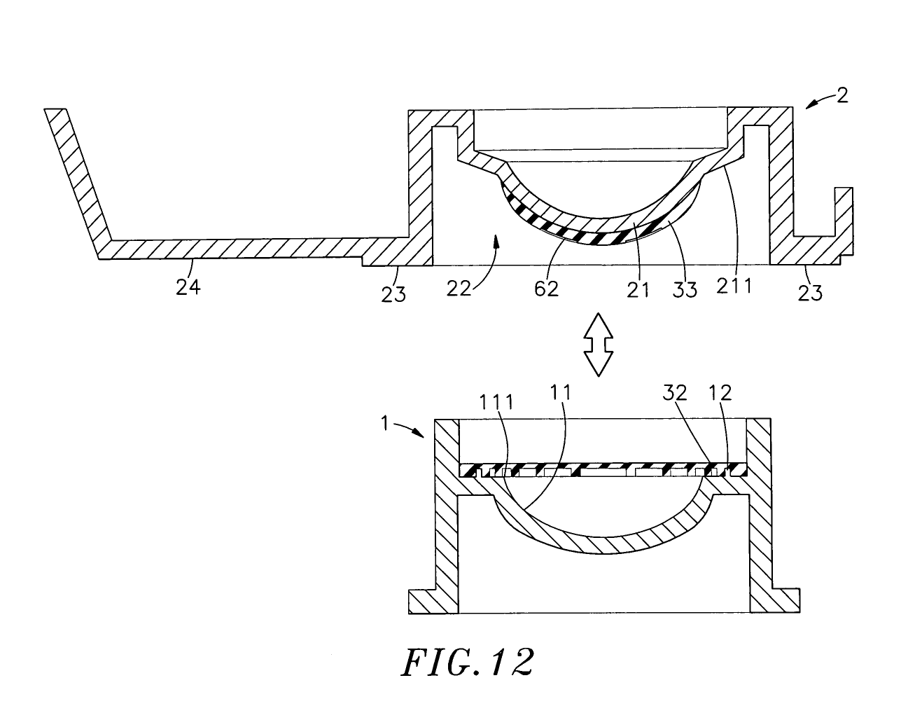

FIG. 13 is a sectional side view of the present invention, showing the color contact lens adhered to the surface of the male molding block of the supplementary tool and a buffer solution filled in the work space of the supplementary tool.

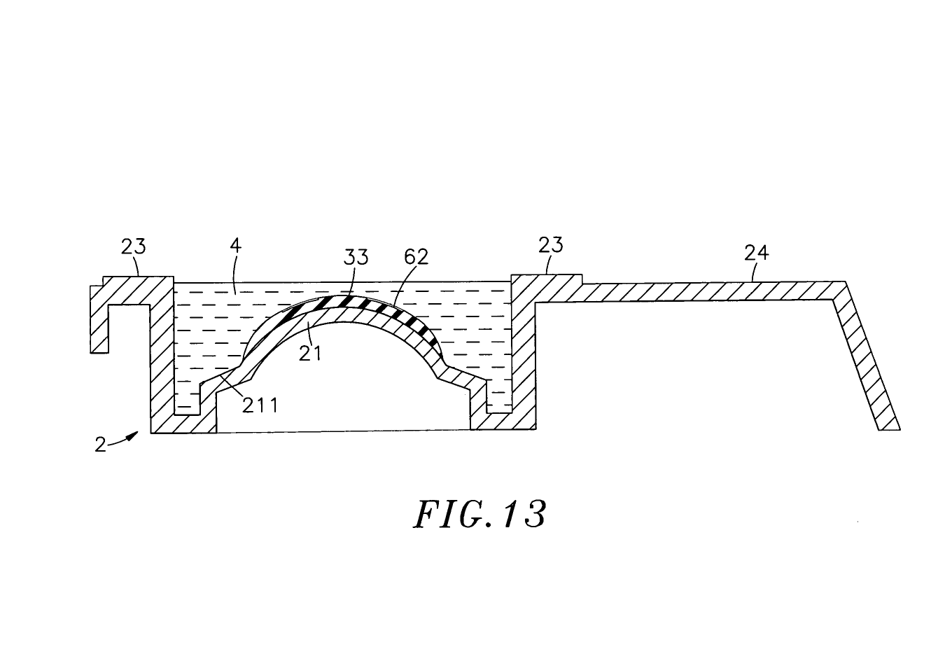

FIG. 14 corresponds to FIG. 13, showing a sealing film sealed to the sealing plane of the supplementary tool.

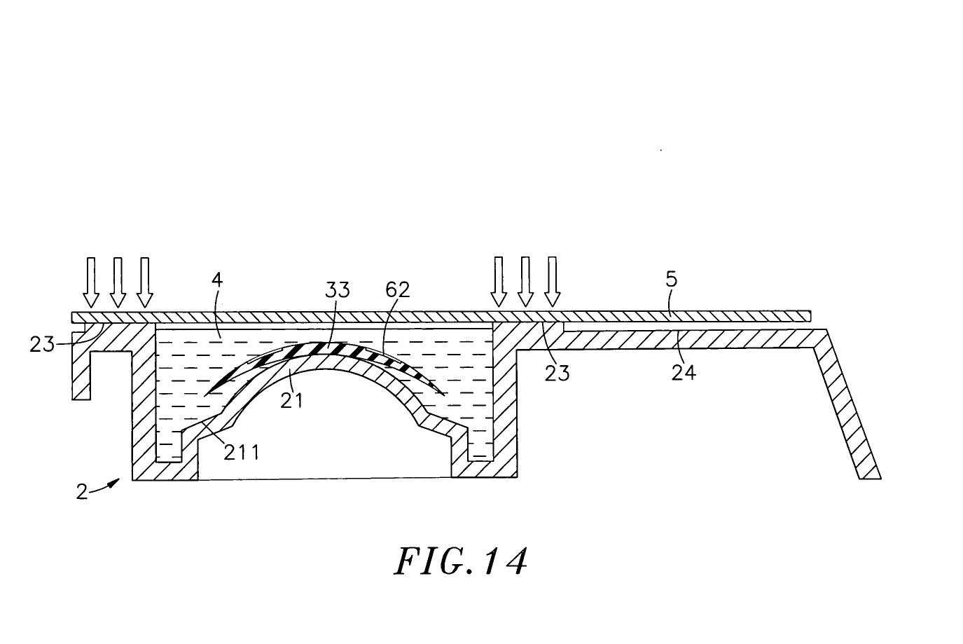

### DETAILED DESCRIPTION OF THE PREFERRED EMBODIMENT

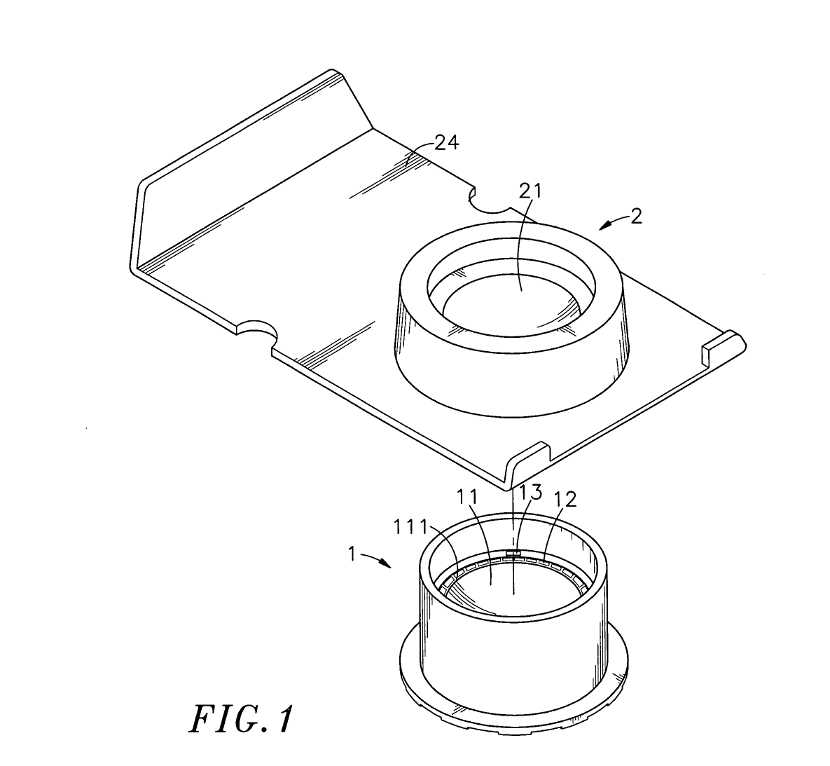

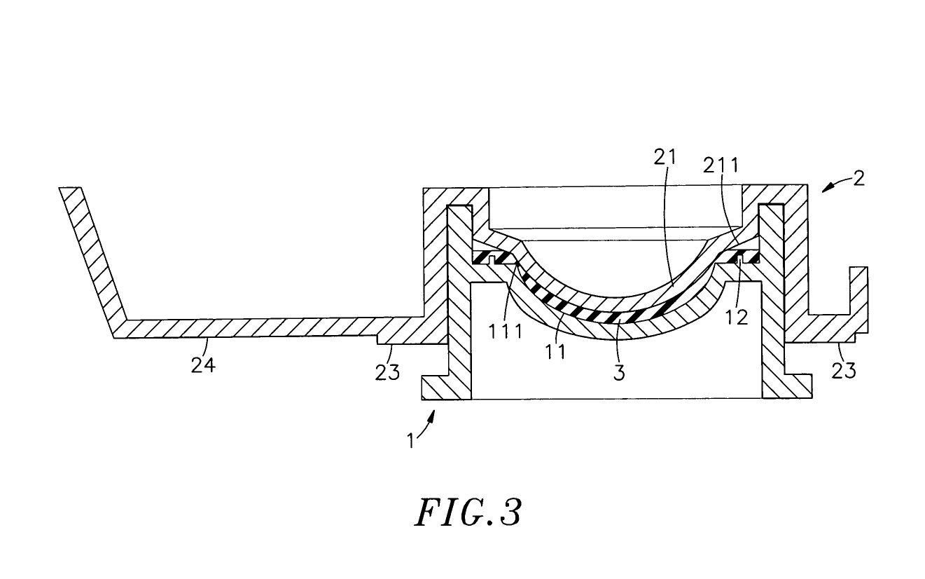

Referring to FIGS. 1-3, a contact lens fabrication tool in accordance with the present invention is shown comprising a mold 1 and a supplementary tool 2.

The mold 1 has a cavity 11 that curves smoothly inwards and has a cut angle of sharp edge 111 on the border, a plurality of locating blocks 12 arranged around the cut angle of sharp edge 111, and an air filling hole 13 disposed beyond but in air communication with the cavity 11 for the injection of compressed air into the cavity 11. The air filling hole 13 may be not requisite.

The supplementary tool 2 comprises a downwardly extending work space 22 fitting the mold 1, a male molding block 21 curved smoothly downwards in the work space 22 and fitting the curvature of the cavity 11, a sloping bearing surface 211 extending around the periphery of the male molding block 21, a sealing plane 23 extending around the bottom side of the work space 22, and a flat panel 24 outwardly extending from the sealing plane 23.

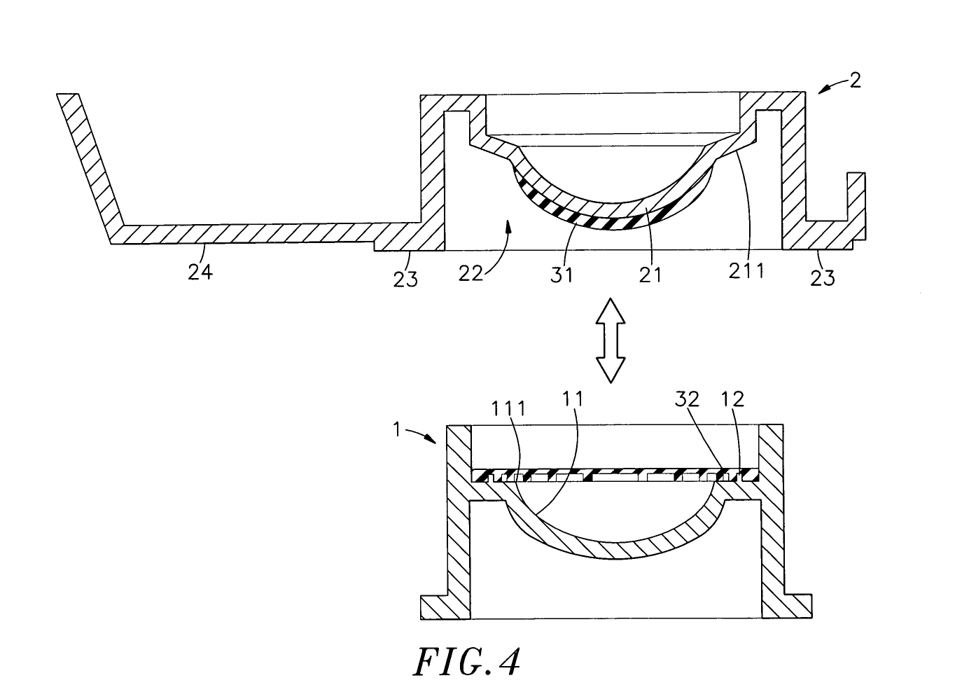

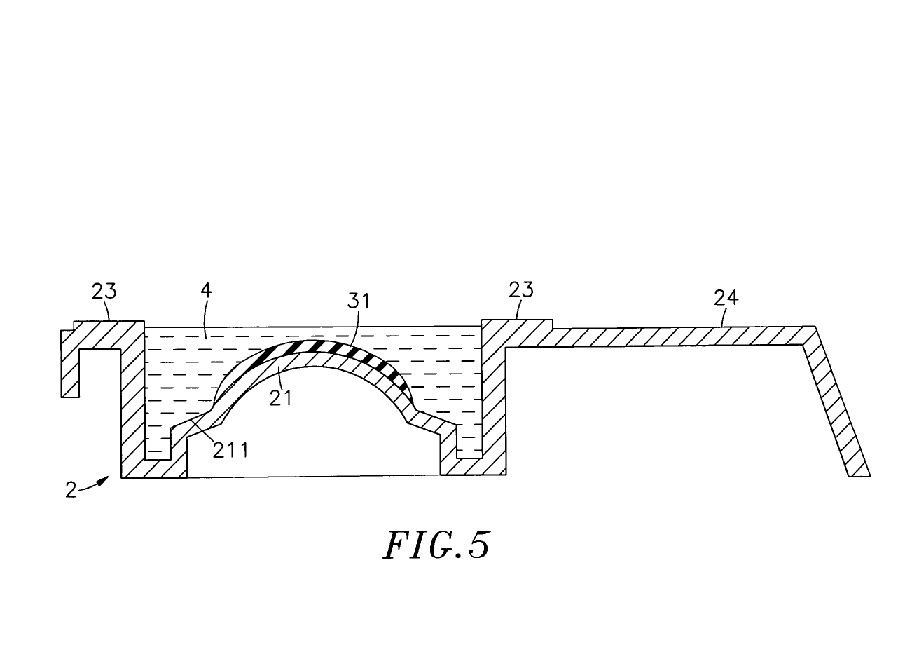

During the use of the aforesaid contact lens fabrication tool, contact lens material 3 is put in the cavity 11 of the mold 1, and then the supplementary tool 2 is operated to force the male molding block 21 into the cavity 11 of the mold 1. At this time, the downward pressure from the male molding block 21 causes the contact lens material 3 to spread out evenly in the cavity 11 and also to spread over the cut angle of sharp edge 111 into the space outside the cavity 11 around the locating blocks 12 and within the work space 22. When increasing the pressure that is being applied to the male molding block 21 against the cavity 11 of the mold 1, the connection portion between the sloping bearing surface 211 and the male molding block 21 acts against the cut angle of sharp edge 111, thereby cutting off waste material of overflowed part 32 of the contact lens material 3 that is beyond the cut angle of sharp edge 111. By means of the application of a heating process, the shape-formed contact lens material 3 is cured, forming a contact lens 31. Thereafter, the supplementary tool 2 is separated from the mold 1 (see FIG. 4). At this time, the contact lens 31 is adhered to the male mold block 21 of the supplementary tool 2. The supplementary tool 2 is then turned upside down for allowing examination of the contact lens 31, and then a buffer solution 4 is filled in the work space 22 of the supplementary tool 2 after the contact lens 31 passed the examination (see also FIG. 5), and then a sealing film 5 is sealed to the sealing plane 23 of the supplementary tool 2 through a heat sealing process to package the supplementary tool 2, sealing the buffer solution 4 and the contact lens 31 in the work space 22. The packaged contact lens is then treated with a high-temperature high-pressure sterilization process, and thus the fabrication of the contact lens is done.

According to the contact lens fabrication method of the present invention, one mold 1 is provided, and individual supplementary tools 2 are pressed into the mold 1 one after another to mold one respective piece of contact lens material 3 into shape and to carry the respective contact lens 31 away from the mold 1 for further examination, filling of buffer solution 4, sealing and sterilization. This contact lens fabrication method saves much labor and time, effectively improving the yield rate and lowering the manufacturing cost.

The process of curing the shape-formed contact lens material 3 into a contact lens 31 can be done by means of the radiation of ultraviolet light or the application of a heating process. The contact lens material 3 can be a hydrogel polymer, UV (ultraviolet) solidified polymer or thermosetting polymer. The sealing film 5 can be an aluminum foil, tin foil or thin polymer film.

Further, the smoothly curved surface of the male molding block 21 of the supplementary tool 2 is a surface treated through a corona treatment, flame treatment or UV (ultraviolet) treatment, enhancing its surface adherence strength for the contact lens 31.

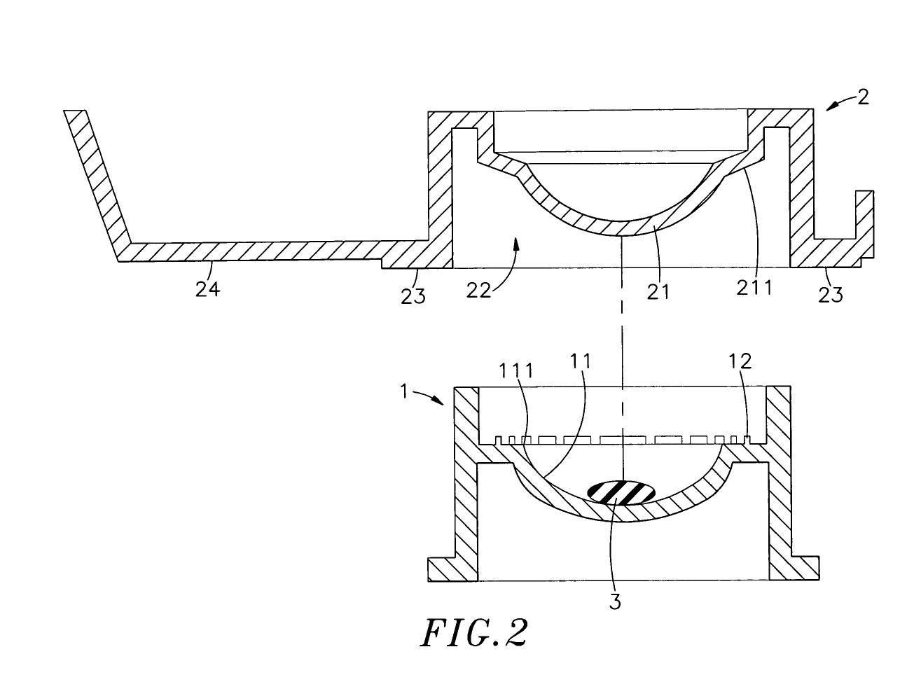

Referring to FIGS. 2˜6, the contact lens fabrication method of the present invention includes the steps of:
100 Put a contact lens material 3 in the cavity 11 of the mold 1;
101 Press the male molding block 21 of the supplementary tool 2 into the cavity 11 to squeeze the contact lens material 3;
102 Increase the pressure of the male molding block 21 to the contact lens material 3 against the cavity 11 of the mold 1, forcing the contact lens material 3 to spread out evenly in the cavity 11 and also to spread over the cut angle of sharp edge 111 into the space outside the cavity 11 around the locating blocks 12 and within the work space 22;
103 Increase the pressure of the male molding block 21 to the contact lens material 3 against the cavity 11 of the mold 1, causing the cut angle of sharp edge 111 to cut off the waste material of overflowed part 32 of the contact lens material 3 that is beyond the cavity 111;
104 Cure the shape-formed contact lens material 3 in the cavity 1 into a contact lens 31 by means of radiation of ultraviolet light or application of a heating process;
105 Separate the supplementary tool 2 from the mold 1 to have the contact lens 31 be adhered to the surface of the male molding block 21 of the supplementary tool 2 and the waste material of overflowed part 32 be left secured to the locating blocks 12 in the mold 1 beyond the cavity 11;
106 Examine the contact lens 31, and then fill a buffer solution 4 into the work space 22 of the supplementary tool 2;
107 Seal a sealing film 5 to the sealing plane 23 of the supplementary tool 2 to seal the buffer solution 4 and the contact lens 31 in the work space 22;
108 A finished contact lens product formed of the supplementary tool 2, the buffer solution 4 and the contact lens 31 is supplied to the market for sale.

As stated above, the process of curing the contact lens material 3 can be done by means of the radiation of ultraviolet light or the application of a heating process. The contact lens material 3 can be a hydrogel polymer, UV solidified polymer, or thermosetting polymer. Further, the sealing film 5 can be an aluminum foil, tin foil or thin polymer film. Further, the smoothly curved surface of the male molding block 21 of the supplementary tool 2 is treated with a surface treatment such as corona treatment, flame treatment or ultraviolet treatment to enhance its surface adherence strength for the contact lens 31.

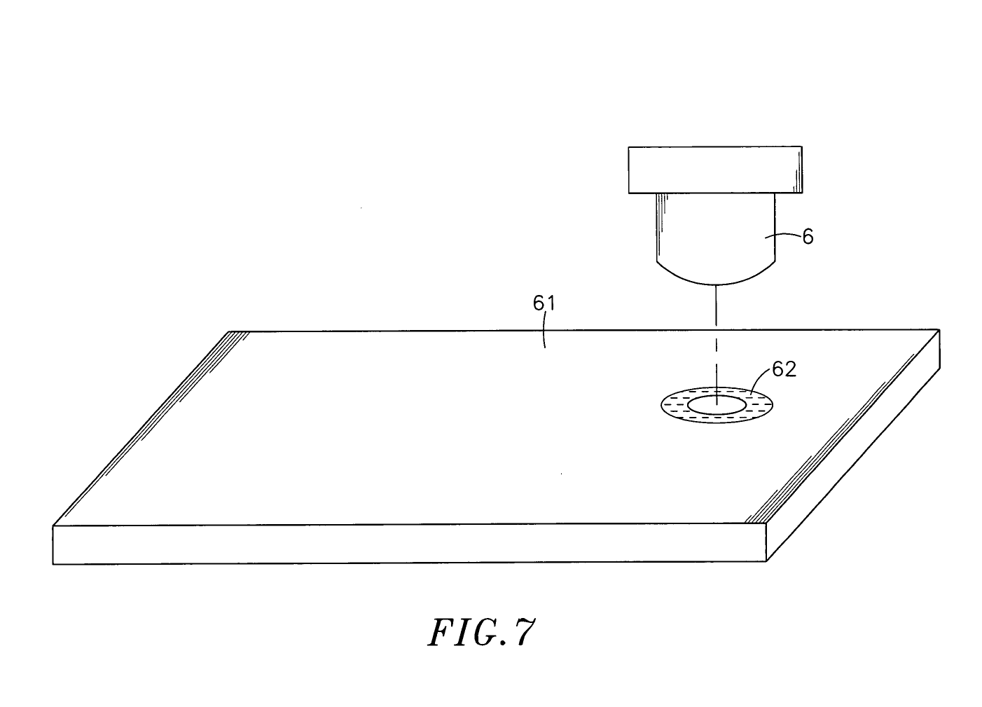

FIGS. 7˜14 show a contact lens fabrication method in accordance with a second embodiment of the present invention. According to this second embodiment, a color printing ink is printed on the surface of the cavity of the mold for the fabrication of a color contact lens. The contact lens fabrication method according to this second embodiment includes the steps of:
200 Print a color printing ink 62 on the surface of the cavity 11 of the mold 1 by means of a transfer printing or spray printing technique;
201 Put a contact lens material 3 in the cavity 11 of the mold 1 in close contact with the color printing ink 62 on the surface of the cavity 11;
202 Press the male molding block 21 of the supplementary tool 2 into the cavity 11 to squeeze the contact lens material 3;
203 Increase the pressure of the male molding block 21 to the contact lens material 3 against the cavity 11 of the mold 1, forcing the contact lens material 3 to spread out evenly in the cavity 11 and also to spread over the cut angle of sharp edge 111 into the space outside the cavity 11 around the locating blocks 12 and within the work space 22;
204 Increase the pressure of the male molding block 21 to the contact lens material 3 against the cavity 11 of the mold 1, causing the cut angle of sharp edge 111 to cut off the waste material of overflowed part 32 of the contact lens material 3 that is beyond the cavity 111;
205 Cure the color printing ink 62 printed and shape-formed contact lens material 3 in the cavity 1 into a color contact lens 33 by means of radiation of ultraviolet light or application of a heating process;
206 Separate the supplementary tool 2 from the mold 1 to have the color contact lens 33 be adhered to the surface of the male molding block 21 of the supplementary tool 2 and the waste material of overflowed part 32 be left secured to the locating blocks 12 in the mold 1 beyond the cavity 11;
207 Examine the color contact lens 33, and then fill a buffer solution 4 into the work space 22 of the supplementary tool 2;
208 Seal a sealing film 5 to the sealing plane 23 of the supplementary tool 2 to seal the buffer solution 4 and the color contact lens 33 in the work space 22;
209 A finished contact lens product formed of the supplementary tool 2, the buffer solution 4 and the color contact lens 33 is supplied to the market for sale.

During the aforesaid contact lens fabrication process, a plastic transfer-printing head 6 is used and dipped in a color printing ink 62 carried on a steel ink pad 61 for transfer-printing the color printing ink 62 on the surface of the cavity 11 of the mold 1. Alternatively, a spray printing technique may be employed to spray print the color printing ink 62 on the surface of the cavity 11 of the mold 1, or to spray printing the color printing ink 62 on the surface of the shape-formed contact lens material 3 after the curing process.

The process of curing the color contact lens 33 can be done by means of the radiation of ultraviolet light or the application of a heating process. The contact lens material 3 can be a hydrogel polymer, UV solidified polymer or thermosetting polymer. Further, the sealing film 5 can be an aluminum foil, tin foil or thin polymer film. Further, the smoothly curved surface of the male molding block 21 of the supplementary tool 2 is treated with a surface treatment such as corona treatment, flame treatment or ultraviolet treatment to enhance its surface adherence strength for the color contact lens 33.

As stated above, the process of curing the contact lens material 3 can be done by means of the radiation of ultraviolet light or the application of a heating process. The contact lens material 3 can be a hydrogel polymer, UV solidified polymer or thermosetting polymer. Further, the sealing film 5 can be an aluminum foil, tin foil or thin polymer film. Further, the smoothly curved surface of the male molding block 21 of the supplementary tool 2 is treated with a surface treatment such as corona treatment, flame treatment or ultraviolet treatment to enhance its surface adherence strength for the cured contact lens 31.

As stated above, the invention uses the supplementary tool 2 and the mold 1 to mold contact lens material 3 into shape, and the shape formed contact lens 31 is cured, and then a buffer solution 4 is filled in the supplementary tool 2 and packaged with the contact lens 31 and the supplementary tool 2 for sale. This fabrication method greatly saves the labor and time, effectively improving the yield rate and lowering the manufacturing cost.

In conclusion, the contact lens fabrication method and tool of the present invention has the following advantages of features:

1. The supplementary tool 2 and the mold 1 are used to mold a contact lens material 3 into a contact lens 31 (or a color contact lens 33) and then cured in the supplementary tool 2, and then a buffer solution 4 is filled in the supplementary tool 2 and packaged with the contact lens 31 (or the color contact lens 33) and the supplementary tool 2 for sale. Therefore, the invention greatly simplifies the fabrication of a contact lens and improves the yield rate, and effectively lowers the manufacturing cost.

2. After curing of the contact lens 31 (or the color contact lens 33) in the supplementary tool 2, the supplementary tool 2 is directly used as a package material to package the contact lens 31 (or the color contact lens 33), saving much the cost.

3. After formation of the contact lens 31 (or the color contact lens 33), the waste material of overflowed part 32 of the contact lens material 3 is separated from the contact lens 31 (or the color contact lens 33) and secured to the locating blocks 12 in the mold 1 beyond the cavity 11. Therefore, the waste material of overflowed part 32 does not hinder the formation the contact lens 31 (or the color contact lens 33).

Although particular embodiments of the invention have been described in detail for purposes of illustration, various modifications and enhancements may be made without departing from the spirit and scope of the invention.

What the invention claimed is:

1. A contact lens fabrication method comprising the steps of:
(a) putting a contact lens material in a cavity of a mold;
(b) pressing a male molding block of a supplementary tool into said cavity of said mold to squeeze said contact lens material;
(c) increasing the pressure of said male molding block to said contact lens material against said cavity of said mold to force said contact lens material to spread out evenly in said cavity and also to spread over a cut angle of sharp edge of said mold outside said cavity;
(d) increasing the pressure of said male molding block to said contact lens material against said cavity of said mold to cause said cut angle of sharp edge to cut off an excessive part of said contact lens material outside said cavity from said shape formed contact lens material within said cavity;
(e) curing said shape-formed contact lens material in said cavity into a contact lens;
(f) separating said supplementary tool from said mold to have said contact lens be adhered to the surface of said male molding block of said supplementary tool and said excessive part of said contact lens material be left in said mold;
(g) examining said contact lens in said mold, and then filling a buffer solution into said supplementary tool to have said contact lens be dipped in said buffer solution;
(h) sealing a sealing film to said supplementary tool to seal said buffer solution and said contact lens to the inside of said supplementary tool;
(i) obtaining a finished contact lens product formed of said supplementary tool, said buffer solution and said contact lens.

2. The contact lens fabrication method as claimed in claim 1, wherein said contact lens material is a hydrogel polymer.

3. The contact lens fabrication method as claimed in claim 1, wherein the step (e) of curing said shape-formed contact lens material in said cavity into a contact lens is to cure said shape-formed contact lens material by means of ultraviolet light.

4. The contact lens fabrication method as claimed in claim 1, wherein the step (e) of curing said shape-formed contact lens material in said cavity into a contact lens is to cure said shape-formed contact lens material by means of a heating process.

5. The contact lens fabrication method as claimed in claim 1, wherein said sealing film used in the step (h) of sealing a sealing film to said supplementary tool to seal said buffer solution and said contact lens to the inside of said supplementary tool is an aluminum foil.

6. The contact lens fabrication method as claimed in claim 1, wherein said sealing film used in the step (h) of sealing a sealing film to said supplementary tool to seal said buffer solution and said contact lens to the inside of said supplementary tool is a tin foil.

7. The contact lens fabrication method as claimed in claim 1, wherein said sealing film used in the step (h) of sealing a sealing film to said supplementary tool to seal said buffer solution and said contact lens to the inside of said supplementary tool is a thin polymer film.

8. A contact lens fabrication method comprising the steps of:
(a) printing a cavity of a mold with a color printing ink;
(b) putting a contact lens material in said cavity of said mold in close contact with said color printing ink on the surface of said cavity;
(c) pressing a male molding block of a supplementary tool into said cavity of said mold to squeeze said contact lens material;
(d) increasing the pressure of said male molding block to said contact lens material against said cavity of said mold to force said contact lens material to spread out evenly in said cavity and also to spread over a cut angle of sharp edge of said mold outside said cavity;
(e) increasing the pressure of said male molding block to said contact lens material against said cavity of said mold to cause said cut angle of sharp edge to cut off an excessive part of said contact lens material outside said cavity from said shape formed contact lens material within said cavity;
(f) curing said color printing ink printed and said shape-formed contact lens material in said cavity into a color contact lens;
(g) separating said supplementary tool from said mold to have said color contact lens be adhered to the surface of said male molding block of said supplementary tool and said excessive part of said contact lens material be left in said mold;
(h) examining said color contact lens being carried in said supplementary tool, and then filling a buffer solution into said supplementary tool to have said color contact lens be dipped in said buffer solution;
(i) sealing a sealing film to said supplementary tool to seal said buffer solution and said color contact lens to the inside of said supplementary tool;
(j) obtaining a finished contact lens product formed of said supplementary tool, said buffer solution and said color contact lens.

9. The contact lens fabrication method as claimed in claim 8, wherein said contact lens material is a hydrogel polymer.

10. The contact lens fabrication method as claimed in claim 8, wherein the step (f) of curing said shape-formed contact lens material in said cavity into a color contact lens is to cure said shape-formed contact lens material by means of ultraviolet light.

11. The contact lens fabrication method as claimed in claim 8, wherein the step (f) of curing said shape-formed contact lens material in said cavity into a color contact lens is to cure said shape-formed contact lens material by means of a heating process.

12. The contact lens fabrication method as claimed in claim 8, wherein said sealing film used in the step (i) of sealing a sealing film to said supplementary tool to seal said buffer solution and said color contact lens to the inside of said supplementary tool is an aluminum foil.

13. The contact lens fabrication method as claimed in claim 8, wherein said sealing film used in the step (i) of sealing a sealing film to said supplementary tool to seal said buffer solution and said color contact lens to the inside of said supplementary tool is a tin foil.

14. The contact lens fabrication method as claimed in claim 8, wherein said sealing film used in the step (i) of sealing a sealing film to said supplementary tool to seal said buffer solution and said color contact lens to the inside of said supplementary tool is a thin polymer film.

15. The contact lens fabrication method as claimed in claim 8, wherein the step (a) of printing a cavity of a mold with a color printing ink is to use a plastic transfer-printing head to transfer-print said color printing ink from a steel ink pad to the surface of said cavity of said mold.

16. The contact lens fabrication method as claimed in claim 8, wherein the step (a) of printing a cavity of a mold with a color printing ink is done by means of a spray printing technique.

17. A contact lens fabrication tool, comprising:
a mold, said mold comprising a cavity, said cavity curving smoothly inwards, and a cut angle of sharp edge extending around the border of said cavity;
a supplementary tool, said supplementary tool comprising a downwardly extending work space fitting said mold, a male molding block curved smoothly downwards in said work space for insertion into said cavity of said mold to squeeze a contact lens material into shape, a sloping bearing surface extending around the periphery of said male molding block, and a sealing plane extending around a bottom side of said work space.

18. The contact lens fabrication tool as claimed in claim 17, wherein said mold further comprises a plurality of locating blocks disposed outside said cavity, and an air filling hole disposed outside and in air communication with said cavity.

19. The contact lens fabrication tool as claimed in claim 18, wherein said locating blocks of said mold are arranged around said cut angle of sharp edge.

20. The contact lens fabrication tool as claimed in claim 18, wherein said male molding block is treated with a surface treatment to provide a surface adherence strength for said contact lens material to be molded.

21. The contact lens fabrication tool as claimed in claim 20, wherein said surface treatment is a corona treatment.

22. The contact lens fabrication tool as claimed in claim 20, wherein said surface treatment is a flame treatment.

23. The contact lens fabrication tool as claimed in claim 20, wherein said surface treatment is a ultraviolet light treatment.
